(19) United States
(12) Patent Application Publication
(10) Pub. No.: US 2013/0060488 A1
(43) Pub. Date: Mar. 7, 2013

(54) IMAGE PROCESSING SYSTEM AND METHOD FOR NDT/NDI TESTING DEVICES

(71) Applicants: Ehab Ghabour, Northborough, MA (US); Daniel Stephen Kass, Attleboro, MA (US)

(72) Inventors: Ehab Ghabour, Northborough, MA (US); Daniel Stephen Kass, Attleboro, MA (US)

(73) Assignee: OLYMPUS NDT INC., Waltham, MA (US)

(21) Appl. No.: 13/224,874

(22) Filed: Sep. 2, 2011

(51) Int. Cl. G06F 19/00

(52) U.S. Cl. 702/38; 702/39

(57) ABSTRACT

A system and method suitable for producing user designated views of non-destructive inspection target with adjustable color, opacity and/or fill-patterns in coordination of the display of inspection scan images. The geometric definition of the inspection target and the inspection scan area are both prepared by independent processes under which vertices and respective primitives are established. The inspection target primitives are given an alpha texture that includes color, opacity and/or fill-pattern designated by the user. The scan area primitives are mapped by a color and/or opacity texture representing inspection signal information such as amplitude. An efficient commercially available graphics accelerator is used to render both of the images of inspection target's chosen view and that of scanned area. The method allows implementation in real-time and on hand-held devices.

### FIELD OF THE DISCLOSURE

The present disclosure generally relates to an improved image processing system and method for non-destructive testing and inspection (NDT/NDI) devices and, more particularly, to an image processing system and method that uses a hardware graphics accelerator and associated software to provide high performance image rendering of both inspection scan area and test object's geometric definitions.

### BACKGROUND OF THE DISCLOSURE

NDT/NDI devices have been used in industrial applications for more than sixty years. They are widely used for flaw detection to find hidden cracks, voids, porosity, and other internal discontinuities in solid metals, composites, plastics, and ceramics, as well as for measuring thickness and analyzing material properties. NDT/NDI devices primarily include single element ultrasonic (UT), phased array ultrasonic (PA) and eddy current (EC) devices.

The effort of presenting accurate, rich and high quality display images of inspection signals largely falls into two categories for the array of NDT/NDI devices. The effort representing the first category focuses largely on increasing the density and richness of the inspection data by plotting increasingly more inspection points in an image format, i.e., evolving from a single focal beam generated A-scan to a multi-focal beam generated phased array S-scan. An S-scan provides an advantage for flaw rendering because it enables the inspector to use a stationary transducer to see a virtual two dimensional region inside of the test material rather than just a single point, as is provided by an A-scan measurement.

The other category of the effort that has been seen to improve visualization of the existing inspection data of any scan-type, such as planar C-scan, PA linear scan, end view scan etc., involves highlighting or adding colors to the scanned data, or to certain selected scanned area according to some analysis requirement. Some of these efforts make use of computer graphics tools to render a scanned shape with different colors.

One example in the latter group of effort is presented by a US patent application, US2010-0104132-A1 (later as '132), made by the present Applicant. In '132, an exemplary S-scan scanned area is mapped into vertex coordinates and primitives to create a surface. The surface is then given a color texture representing S-scan signal amplitude information. An efficient commercially available graphics accelerator is used to render color image efficiently based on the input of the vertex coordinates, primitives and the color texture.

With the existing effort focusing on processing inspection signals such as rendering the ultrasonically scanned area image in many types of scans, the efficient visualization of the whole or portion of the test objects and/or its features remains unsolved. In addition, existing display and measurement tools used for displaying test target geometries involving using features such as image grid, gates that select measurement regions, X and Y cursors for point and area measurements and part thickness indicators are not efficiently visualized. It has become difficult to visually differentiate these display features from one another or from the inspection results.

In NDT/NDI operations, the geometric definitions of the test objects, including their cross-sections, are usually retrieved from computer aided design tools (CAD) including embedded instrument software or PC drawing tools. They are not obtained by inspection signals such as ultrasonic scans. In existing solutions, test objects or the cross-sections of the same are simply outlined or delineated by mostly solid lines of different colors. The drawbacks of such approaches include i) the area and/or the shape of the test objects are not as visually identifiable as those objects with the whole shape rendered with certain shades and/or color; ii) the solid outlines of the test objects, their cross-sections and/or operator defined measurement tools visually interfere with images of the defects and iii) the representation of the test objects are not as versatile.

FIGS. 1a and 1b show an existing method of delineating the outline of a weld being inspected. As can be seen in both FIGS. 1a and 1b, the shape of weld 4 is only limited to be delineated by lines 4a and 4b. The shape of weld 4 is not rendered or treated with color or any level of opacity, and therefore is not visually enhanced. Lines 4a and 4b might visually interfere with the ultrasonic inspection scan result as shown in FIG. 1b.

The embodiments of the present disclosure are intended to address the above drawbacks of the existing solutions and improve the visualization of the geometric features of the test objects while making use of existing techniques presenting inspection signals.

### SUMMARY OF THE INVENTION

The invention disclosed herein provides a method and system to render views of non-destructive inspection target test object with desirable color and/or opacity, coordinating the image rendering of the inspection signals in real time, and avoiding the existing methods which outline test objects only with solid lines, presenting drawbacks such as lack of visualization and sometimes obscuring small flaws shown from inspection results.

Accordingly, it is a general object of the present disclosure to provide a method and a system suitable for producing both test object images and inspection scan images, each of which with combination of color, opacity and/or fill patterns.

It is further an object of the present disclosure to improve visualization of images of both the test object and the inspection scan data by making use of efficient and powerful graphics accelerators so that it can be deployed in real-time and on hand-held devices.

It is further another object of the present disclosure to allow the test object to be displayed with an adjustable level of transparency to improve the visualization of both test object and inspection scan images, and to not obscure the detected flaws, particularly when flaws are small in size.

It is further another object of the present disclosure to allow the NDT/NDI operator to mark and select any area of test object, apply any desirable level of color, opacity, fill-patterns or any combination of them to improve the visual effect of the inspection result.

The foregoing and other objectives, advantages and features of the present invention will become more apparent upon reading of the following non restrictive description of illustrative embodiments, given for the purpose of illustration only with reference to the appended drawings.

### BRIEF DESCRIPTION OF THE DRAWINGS

The patent or application file contains at least one drawing executed in color. Copies of this patent or patent application publication with color drawing(s) will be provided by the US Patent and Trademark Office upon request and payment of the necessary fee.

FIGS. 1a and 1b present prior-art ultrasonic scans of a typical weld, with the geometry of the weld delineated only by solid lines.

FIG. 2 is a schematic diagram showing the vertexes and primitives that are established for a cross-section of the exemplary weld.

FIG. 3 is a schematic diagram showing the vertexes and primitives of both the scan-area and the cross-section of the inspection target (the exemplary weld) that are established in a primary and a secondary coordinate system.

FIG. 4 is a schematic diagram of the presently disclosed image processing system comprising functional modules, the system being configured to generate display images with both the target object surface identified with color and/or opacity as assigned by operator and within the scanned surface shown with a desirable texture.

FIG. 5 is a function block diagram showing the process executed by the Test Object Surface Generator Module.

FIG. 6 is a function block diagram showing the process executed by test object surface texture generator.

FIG. 7 is a function block diagram showing the process of how the rendered image representing the scanned data and the rendered image of test object geometry are combined and displayed.

FIGS. 8a and 8b are colored screen shots inspection results from the inspection instrument which employs the presently disclosed embodiments treating test object and scan area with varied color and/or opacity.

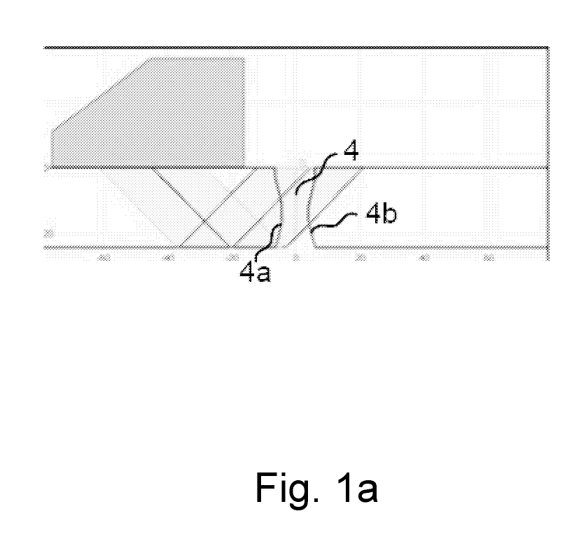

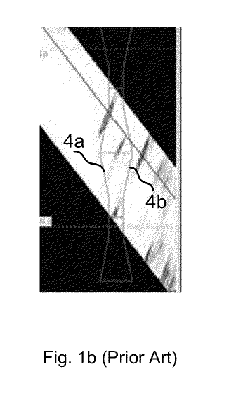

### DETAILED DESCRIPTION OF THE PRESENT DISCLOSURE

The following describes a method and an NDT/NDI system (not shown) employing the method to improve the visualization of any portion or cross section of a test object according to the present disclosure. A double V weld is used as an exemplary NDT/NDI inspection test object in the following description. It should be appreciated that the test object and its associated defects and characteristics, such as thickness, can be in many geometric forms.

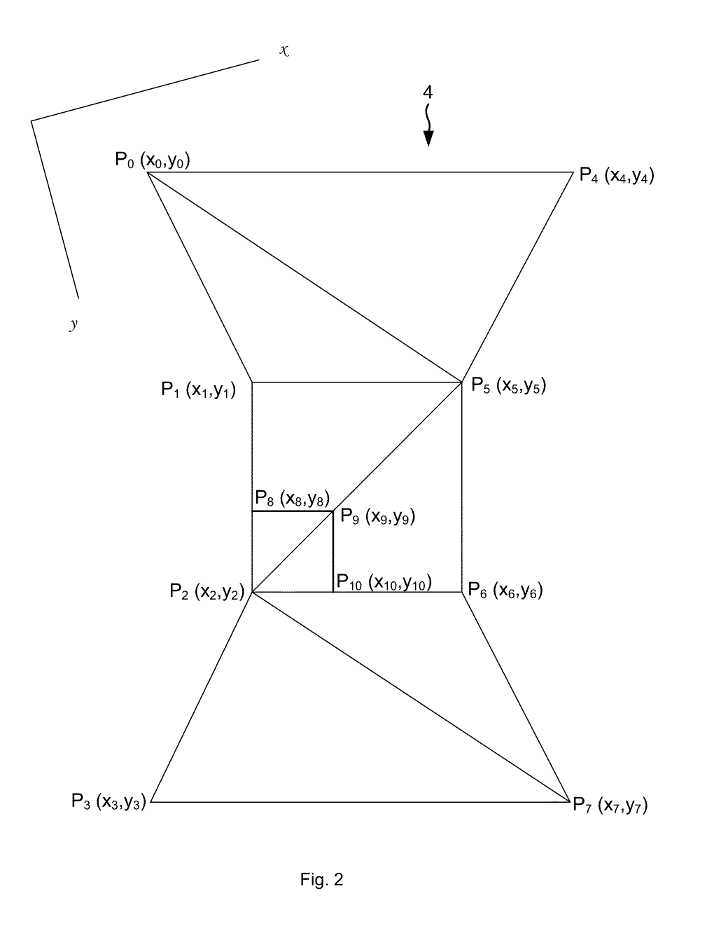

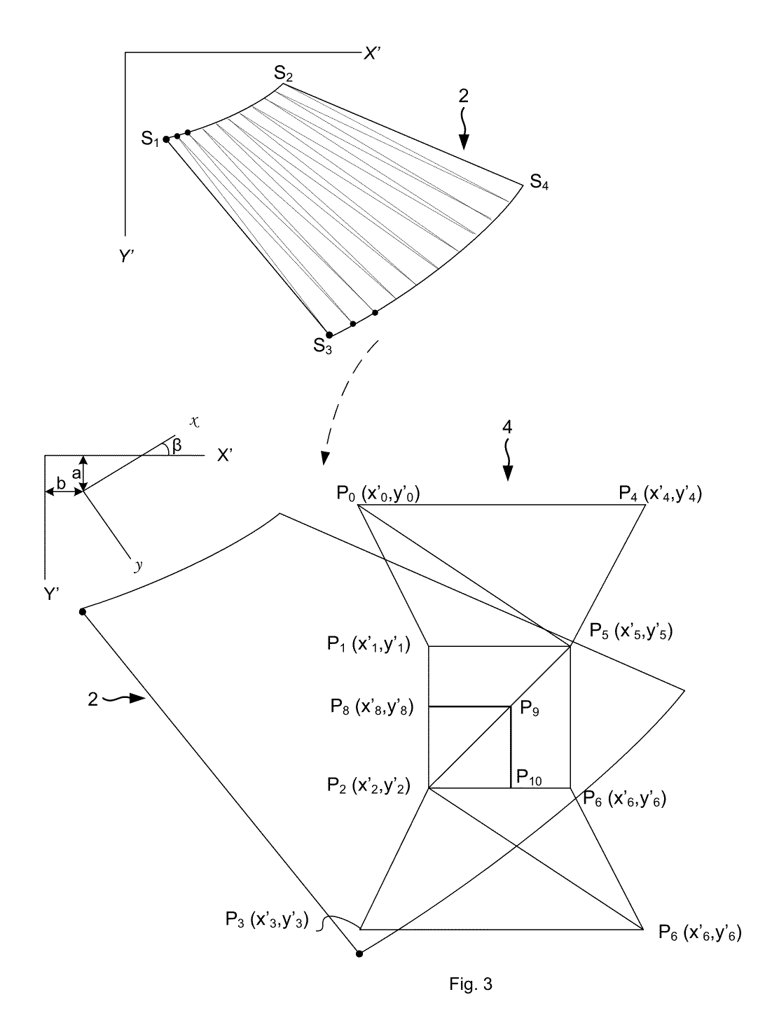

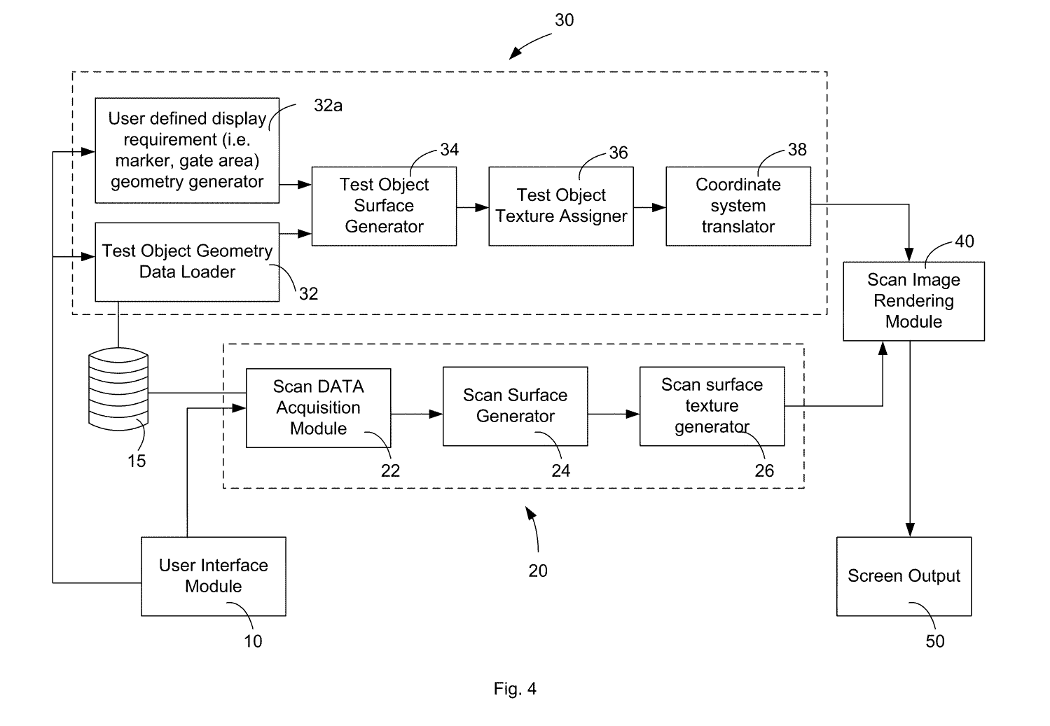

Referring to FIGS. 2 and 3, the contour of an exemplary weld 4 (FIG. 3) is delineated by eight points P₀, P₁, . . . , P₇. As in many types of NDT/NDI operations, the geometry of the inspection or test target is often predetermined by computer aided design (CAD) tools and described as CAD data. Other CAD type drawing tools may also be embedded within the NDT/NDI device. The CAD data can often be stored in a data storage device 15 shown in FIG. 4 and retrieved by the NDI/NDT device. It can be readily understood that the method and associated computer program modules in the present disclosure are preferably loaded on and executed by signal processing circuits on the NDT/NDI device (not shown).

One of the principal objectives of the present disclosure is to prepare the exemplary shape weld 4 enclosed by P₀, P₁, . . . , P₇ as a surface. As shown in FIG. 2, P₀, P₁, . . . , P₇ are used as vertexes. Using lines connecting the vertexes such as P₀P₄, P₄P₅ and P₅P₀, weld shape 4 is then divided into triangles, called “primitives”. With the primitives defined, the surface is suitable to be treated by an image rendering process called “alpha blending” or “being applied with an alpha value” by employing some commercially available computer graphics tools.

Turning vertices into surfaces and subsequently rendering the surfaces with different alpha values for graphic attributes, such as color, patterns and opacity is well known in the arts. Some exemplary basic steps of how to render surfaces of any size and shape into primitives and how to give a surface textures are illustrated in details in a book “Real Time rendering in DirectX” (later as “DirectX”) by Kelly Dempski”, published by Premier Press, in pages 134, 135, 136, 137, 138, 194, 195 and 196, the contents of which are annexed hereto as pages 13-20.

It can be further seen in FIG. 2 that the geometry of a cross section of exemplary weld 4 is also defined in an exemplary 2-D coordinate system x-y as shown. The eight points defining weld 4 have coordinate values of P₀(x₀, y₀), P₁(x₁, y₁), . . . , P₇(x₇, y₇) respectively. It can be appreciated by those skilled in the art that the coordinate values of any point in any of the established primitives can be deduced and therefore defined. It also should be appreciated by those skilled in the art that a 3-D system can be used for defining the geometry of weld 4.

Continuing with FIG. 2, it is often desirable in NDT/NDI operations that one can select and highlight a special area of interest within the test object. With the whole test object geometry defined in the coordinate system x-y and all the vertices and primitives defined in the way described above, any portion within the boundary defined by P₀(x₀, y₀), P₁(x₁, y₁), . . . , P₇(x₇, y₇) can be further defined. For example, one might be interested in an area encircled by P₂ P₈ P₉ P₁₀. It can be appreciated that corresponding coordinate values (x₂, y₂), (x₈, y₈), (x₉, y₉), and (x₁₀, y₁₀) can be readily deduced by those skilled in the art. Vertices and primitives within this selected area can be established as P₂ P₈ P₉ and P₂ P₉ P₁₀.

With the established surface, vertexes and predetermined textures as input, a graphics accelerator can be used to render images of any combination of color, opacity and/or fill-in patterns very efficiently.

One of the novel aspects of the present disclosure include the steps of 1) converting the geometry of the target or test object into surface with primitives, 2) applying predetermined alpha values to the test object primitives, then, 3) converting the inspection scan areas into primitives and give the scan area primitives a texture by mapping the colorized or other alpha values corresponding to inspection signal information onto corresponding scan area primitives, 4) overlapping, or overlaying the test object primitives and the scan area primitives, and finally 5) making use of a graphics accelerator to generate the alpha images both on the test object primitives and the scan area primitives on an electronic display.

Step 3) of the above described method is further elaborated by the aforementioned co-pending US patent application, US2010-0104132-A1 ('132), made by the present Applicant, the entirety of which is herein incorporated by reference. In '132, an exemplary S-scan scanned area is mapped into vertex coordinates and primitives to create a surface. The surface is then given a colored texture representing the S-scan signal amplitude information over the corresponding primitives.

Reference is now made to FIG. 3 which shows how the test object surface and the scanned surface are overlaid onto each other. As shown in FIG. 3, x′-y′ is defined as the coordinate system for inspection scan area 2. Also as shown in FIG. 2 that the test object geometry and the associated primitive surface 4 are defined in x-y coordinated system. The relationship between the two coordinate systems x-y and x′-y′ can be expressed in a general term as in Eq. 1, which is widely taught and known to those skilled in the art.

x′=x cos β−y sin β+a

y′=x sin β+y cos β+b Eq. 1

The scan area coordinate system x′-y′ is preferably used as the ‘primary’ coordinate system. The coordinate values of primitives of the test object, such as those of P₀(x₀, y₀), P₁(x₁, y₁), . . . , P₇(x₇, y₇), are therefore converted to coordinate values in x′-y′ system in the manner, according to Eq. 1.

In the last step, the surface representing the inspection signals and the surface representing the test target 4, both with established primitives and texture is provided to a graphics accelerator so that both inspection scan image and the test target can be rendered and presented on a display very efficiently. It should be noted that the alpha value for the test target surface can be assigned by the user to seek any desired combination of opacity and color to better visualize the image of the inspection result. The alpha values for inspection scan signals and scan area are determined by the received inspection signal for each corresponding primitive.

Use of a commercially available graphics accelerator and a graphics software, instead of a custom proprietary designed solution, reduces considerably the time needed to design the graphics system solution, and the complexity of the resulting hardware and software design solution is also reduced.

Reference is now made to FIG. 4. The imaging process given by the foregoing description is preferably executed by a preferred embodiment comprised of computer executable modules in the present disclosure. Referring to FIG. 4, the image processing system includes a user interface module 10, a storage device 15, a scan area surface treatment module 20, a test object geometry treatment module 30, an image rendering module 40 and a screen output 50.

Scan area surface treatment module 20 further includes a scan data acquisition module 22, scan surface generator 24 and a scan surface texture generator 26. Test object geometry treatment module 30 further includes a test object geometry data loader 32, a user defined display requirement generator 32a, a test object surface generator 34, a test object texture assigner 36 and a coordinated system translator 38.

It should be noted that the coordinate system translator 38 can be optionally included either by scan area surface treatment module 20 or test object geometry treatment module 30.

User Interface Module 10 is a keypad and/or remote control console provided to the NDT/NDI device.

One can refer to the previously referred co-pending US patent application, US2010-0104132 for further details on the process pertaining to the operation within scan area surface treatment module 20.

Continuing with FIG. 4, in existing practice, detailed test target geometry definition is mostly provided by CAD tools and stored by storage device 15. User defined test object geometry, desired view or cross-section, analyzing markings, etc. are preferably provided via user interface module 10. Test object geometry data loader 32 retrieves geometry definition data according to the input made via user interface module 10.

User defined special display requirements for selecting a desired portion of the test object for display are executed by user defined display requirement generator 32a. As described in the foregoing section, in NDT/NDI inspection operations, markers and/or areas selected by certain gate criteria are often used to select a portion of the test object, such as the portion encircled by P₂ P₈ P₉ P₁₀ (in FIG. 3). Corresponding geometric definition data pertaining to area P₂ P₈ P₉ P₁₀ is retrieved by 32a according to the instruction given by user interface module 10.

Continuing with FIG. 4, target geometry area, either defined by user defined display generator 32a or defined by test object geometry data loader 32, is provided to test object surface generator 34. The surface vertexes and primitives for weld 4 are generated by test object surface generator 34. Desired texture attributes are preferably assigned by the operator and defined via user interface module 10. Test object texture assigner 36 assigns surface 4 (in FIG. 2) a texture that could include any combination of color, opacity and/or patterns assigned by the operator. Image Rendering Module 40 maps the predetermined texture onto the primitives of test object surface, and further maps the textures with screen pixels and produces the weld (or portion of weld) image with desired color and or opacity to the Screen Output 50.

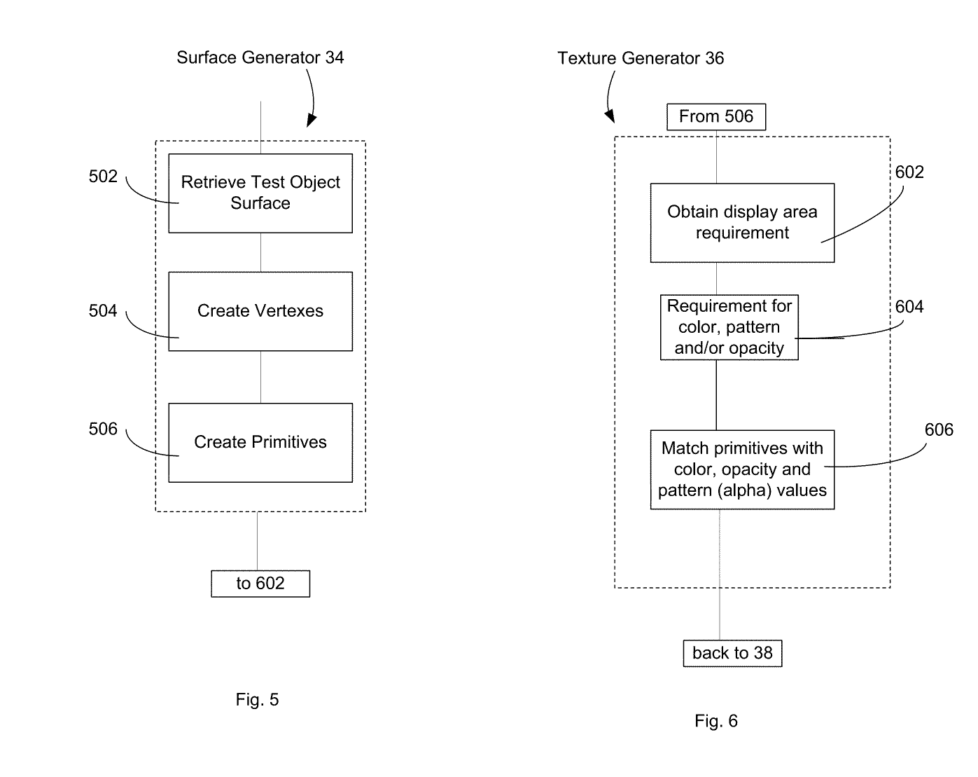

Reference is now made to FIG. 5 and FIG. 6 for further elaboration of the processes executed by test object surface generator 34 and test object surface texture assigner 36, respectively. Object numerals and denotation used in FIGS. 2 and 3 still apply to the following description associated with FIGS. 5, 6 and 7. In FIG. 5, at step 502, the geometric definition data either for the whole test object, or the selected area of test object as described above is loaded. At step 504, vertexes for the test object surface, either of the whole or the selected area are created. At step 506, vertex primitives are created throughout the whole surface 4 or the selected area P₂ P₈ P₉ P₁₀.

Moving to FIG. 6, at step 602, the display requirement for the interested area, either for a cross-section view of the whole object 4 or a selected area P₂ P₈ P₉ P₁₀ is given by the operator and obtained via user interface module 10. In step 604, the requirement (texture) of any level of color, opacity or fill-pattern, or any combination of them for the primitives within the selected display area is retrieved based on operator's input. The texture values for the display requirement are called “alpha values”. It can be appreciated that default alpha values can be pre-assigned to any test object surface which can be altered later by the operator. In step 606, test object texture assigner 36 gives the selected primitives created in step 506 the alpha value determined in step 604 and the texture for the selected surface is created.

At the conclusion of step 606, coordinate system translator 38 in FIG. 4 translates the relative position of the test object geometry either as a whole, or the selected display portion, to the coordinate system of the scan area (x′-y′) as explained in the foregoing description associated with FIG. 3 and Eq. 1.

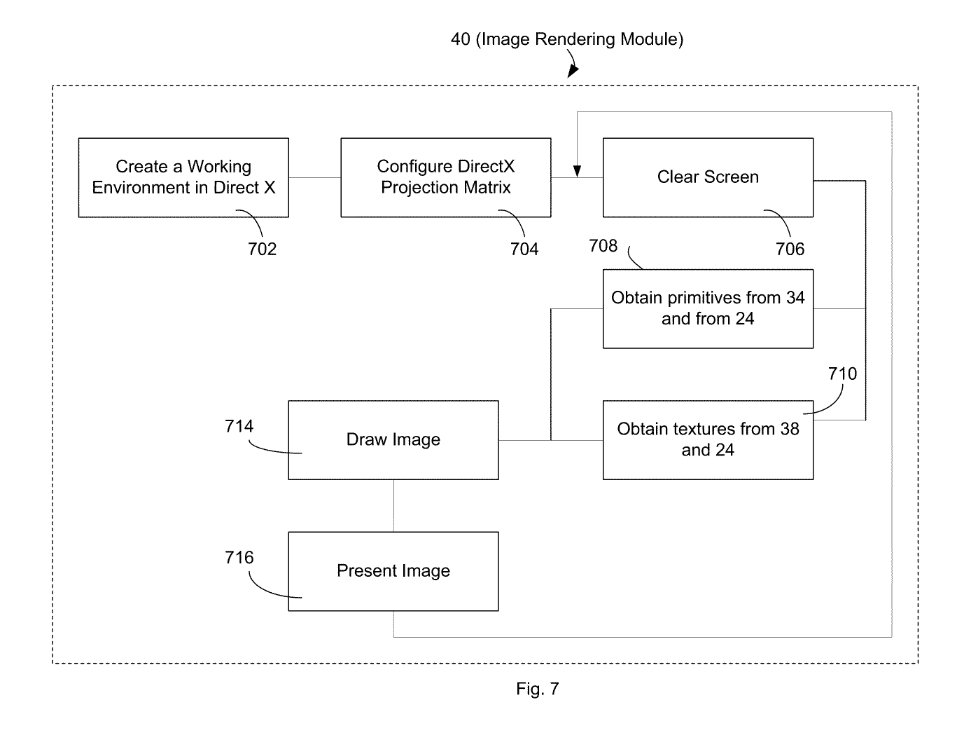

Turning now to FIG. 7, the last step for image rendering takes place when i) the surface 4 or a selected portion of surface 4 with its primitives and its texture from test object texture assigner 36, and ii) the scanned area 2 with its primitives and the corresponding scan area texture reflecting inspection signals, are both provided to the graphics accelerator of Image Rendering Module 40 to render the display image. In this embodiment, DirectX is used to configure Image Rendering Module 40.

It should be appreciate that other computer graphics tools deemed fit for the purpose can be deployed.

A functional block diagram of the Image Rendering Module 40 is shown in FIG. 7. Within the Image Rendering Module 40, a working environment is created in an exemplary graphics tool, DirectX, according to DirectX's requirement at step 702. Then a projection matrix is configured in the graphics accelerator at step 704. At step 706, the screen image is cleared from a previous display session. Then, primitives of both test object and the scan area are obtained at step 708 (primitives of 506 in FIG. 5 and primitives of 606 in FIG. 6 of the co-pending application US2010-0104132-A1 are obtained). At step 710, textures for both scanned area and the test object (coordinate system translated) are obtained from 26 and 38 in FIG. 4, respectively. Combining the above input, at 714, the S-scan and the weld geometry with desired color and/or opacity is provided to screen output 50 of FIG. 4. At step 716, the display of NDT/NDI displays the rendered image according to the screen output at step 714.

In practice, once a testing session is set up for a test object, routines in scan surface generator 22 do not need to be changed for each scan. Similarly, when the subject of interest in the whole test object is determined, the routines in test object surface generator 34 do not need to be changed for each scan either. However, each time there is a change of interest in the views, cross-section, or the marked area for viewing in test object, routines in test object surface generator 34 (602˜606 in FIG. 6) need to be re-run and corresponding primitives need to be regenerated. Configuration steps for DirectX (704) do not need to be changed for each scan or for each test object view set up. That is, only routines in Texture Generator 704-710 in FIG. 7, and routines of 708-716 in FIG. 7 need to be re-run to update the image for each new scan.

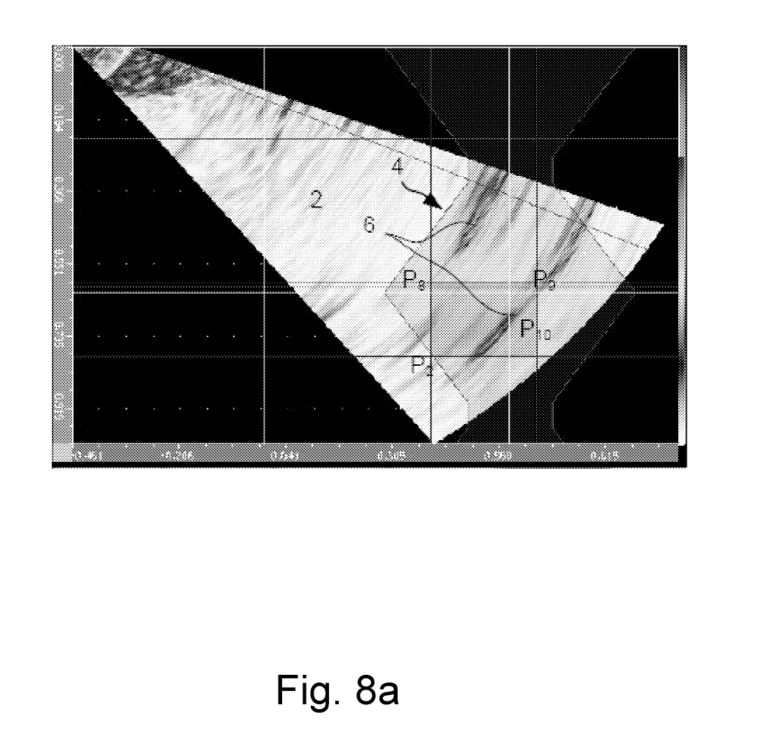

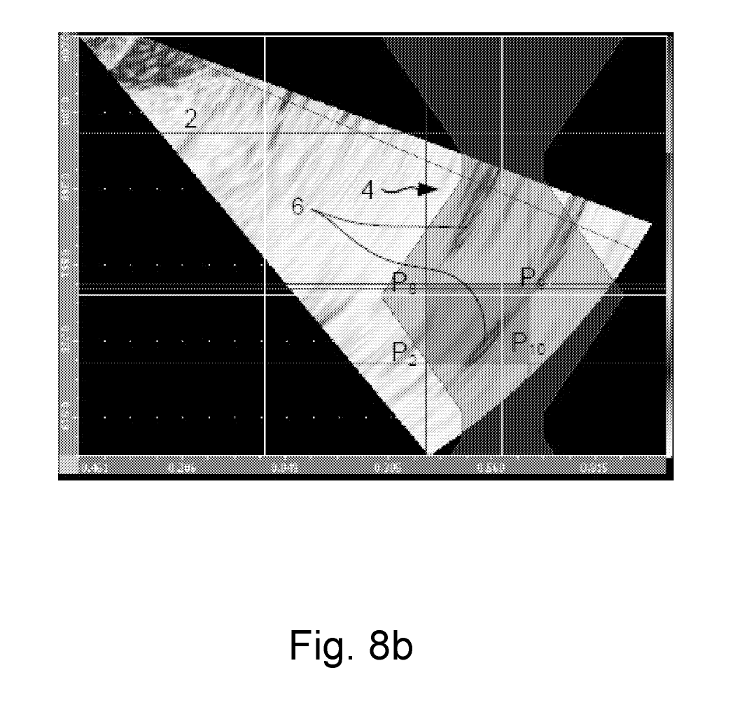

Reference is now made to FIGS. 8a and 8b which are the screen shots produced by the system and method as presently disclosed. As can be seen in FIGS. 8a and 8b, the weld is delineated as area 4, the image of which is generated in part by test object geometry treatment module 30. The ultrasonic S-scan result is delineated by area 2, the result of which is in part generated by the scan area surface treatment module 20 (in FIG. 4). As can be seen weld area 4 is give an exemplary color (rapture rose, pantone #17-19029) with a less degree of opacity and a heavier degree of opacity in FIGS. 8a and 8b, respectively. It should be noted that the opacity in weld area 4 in both FIGS. 8a and 8b are assigned in a fashion so that it enhances the visualization of the scan results, giving clearer indication of geometry relationship between the test object (weld 4) and the ultrasonic scan area 2.

Very importantly, it can be seen that the flaws 6 and other matter of interest of the scan result on scan area 2 are not blocked or obscured by color of test object 4 due to the transparency applied to weld area 4.

It can also be seen that the system and method according to the present embodiments can provide visually versatile marking tools to display inspection images. In FIGS. 8a and 8b, selected area P₂ P₈ P₉ P₁₀ is assigned a color tinted with blue and with opacity a little bit heavier than that in the general weld area 4, to make the marked area more visually distinguishable.

Accordingly, with the capability of presenting any view of the test object in many combinations of color, opacity and/or patterns, the NDT/NDI image data are presented in a much more versatile background. Accommodating the imaging of an NDT/NTI scans, the improved display of the test object, or a portion of the test object significantly improves the visualization of NDT/NDI inspection results. The presently disclosed method of preparation of both inspection scan surface and test object surface in a fashion that commercial graphics tools can be employed, enables highly efficient and real-time display even in hand-held instruments.

The following discussion is taken from a reference book on drawing and introduces the following concepts.
Using vertices to build surfaces.
Rendering surfaces.
Using triangle lists.
Using triangle fans.
Using triangle strips.
Rendering indexed primitives.
Loading and rendering meshes in .X files.
Performance implications of different rendering techniques.
Adding mesh rendering to an application.
   Turning Vertices into Surfaces

Vertices represent positions in space. However, interesting objects occupy many positions in space, and they are most often represented in 3D graphics by their outer surfaces. These outer surfaces are usually represented by triangles. In the case of curved surfaces, you can use sets of triangles to approximate the surface to varying degrees of accuracy. Also, when talking about surfaces, it makes sense to talk about surface normals (vectors that are perpendicular to each surface).

If you are using smooth shading, surface normals are actually represented as vertex normals, where the normal vector for each vertex is the average of the normal vectors for all the triangles that share that vertex.

The standard DirectX lighting model lights surfaces per vertex. This means that the math for lighting is computer for each vertex. Because each triangle has three vertices, the device must interpolate the shaded values across each triangle. The combination of averaged normals as shown in the diagram and interpolated shading across each surface creates the smooth shading shown in most of the renderings in a certain book.

Because you want to add this new piece of information about normals to your vertices, you have to expand your vertex format. You do this by redefining your FVF with the D3DFVF_NORMAL flag. This, along with the position and color information, makes up the minimum format for rendering lit surfaces. Once you revise your vertex format, one can begin talking about how you actually render the triangles themselves.

### Rendering Surfaces

Processing vertices can be expensive if you have too many of them, so the challenge of rendering surfaces becomes how you represent a given surface with a set of triangles and how to do it in the most efficient manner.

It turns out that it is not so easy. For instance, if you are modeling a cylinder, the sides of that cylinder must consist of a collection of flat sides. If you use too few sides, cylinder appears blocky with visible edges. If you use too many sides, you might end up using more data than is actually visible to the eye, causing unnecessary processing. This first problem is usually one an artist must solve using a modeling program, the constraints of the given project, and a little experimentation. Once you know what your geometry is, how do you render that in the optimal way?

You know that vertices are stored in vertex buffers. You also know that you can draw the contents of the vertex buffer by calling DrawPrimitive. You have been using this to draw sets of vertices, but now it's time to talk about triangles. You can draw three types of triangle primitives: the triangle list, the triangle fan, and the triangle strip. Let's look at each type individually and explore the pros and cons of each.

Rendering with Triangle Lists

The triangle list is the easiest of the triangle primitives to understand. Each triangle is represented in the vertex buffer by a set of three vertices. The first three vertices represent the first triangle, the second three vertices represent the second triangle, and so on.

You do this with the following call to DrawPrimitive:
m_pD3DDevice→DrawPrimitive(D3DPT_TRIANGLELIST, 0, 2);

Note that the number of primitives specified in the third parameter is the number of triangles drawn (2), not the number of vertices used (6). This is the easiest way to represent triangles, but FIG. 10.2 also demonstrates the major drawback. Many times, triangles in a continuous surface share common vertices, but in a triangle list, each common point is repeated multiple times. Imagine rendering a cube. Eight points are all you need to define a cube, but has a cube rendered with a triangle list requires 12 triangles and 36 vertices. This means that a triangle list requires the hardware to process 28 more vertices than it needs to. Even in FIG. 10.2, the number of required vertices increases by 50 percent. It makes more sense to reuse vertices, and in fact you can.

Rendering with Triangle Fans

One way of reusing vertices is to use triangle fans. A triangle fan uses the first vertex as a shared vertex for the rest of the vertices.

This is the first example of reusing vertices, and the following code draws two triangles:
m_pD3DDevice→DrawPrimitive(D3DPT_TRIANGLEFAN, 0, 2):

Notice that when drawing two triangles, you still specify two primitives even though the number of vertices used drops from six to four. However, this is not terribly useful because it only applies well to circular or fan-shaped objects. Although you can use triangle fans to produce rectangular shapes, it's usually not the easiest solution. A more general solution is a triangle strip.

Rendering with Triangle Strips

Triangle strips provide a way to reuse vertices by rendering long strips in sequences.

Because vertices are reused, this is a better way of drawing sets of triangles than the triangle list. The code to do this is the same as earlier, with the different primitive type:
m_pD3DDevice→DrawPrimitive(D3DPT_TRIANGLESTRIP, 0, 2):

The important thing to remember about strips is that the order matters. Because every new vertex is coupled with the previous two, you need to make sure that the order makes sense.

Another thing to consider with triangle strips is that sharing vertices does have some drawbacks. For instance, in a hard edged corner, each side has a different surface normal. However, the shared vertex can have only one normal vector. This presents a problem because an averaged normal vector doesn't produce the correct hard edge for the lighting. One way to work around this is to create degenerate triangles. A degenerate triangle is not really visible, but provides a way to transition between vertices by smoothing the normals around the corner. For example, the two sides of the corner have different surface normals, so instead of the two sides sharing different vertices, one can insert a third thin face between them. If this face were larger and actually visible, it would show the effect of the different normals, but because it is extremely thin, you never see it. It is not meant to be visible, only to provide a transition between the faces.

One last thing to consider is that the strips are usually not easy to derive in complex models. There are utilities for breaking models into efficient strips, but they can sometimes complicate the authoring process, and the techniques are not perfect. In a sample code for this embodiment, it is easy to create strips for simple geometric shapes, but the task becomes harder for organic or complex objects such as characters or vehicles. So you have to look for ways to get the vertex to reuse strips and fans without the complication of authoring strips. And again, you can do that.
DWORD Filter, DWORD MipFilter,
D3DCOLOR ColorKey,
D3DXIMAGE_INFO *pImageInfo,
PALETTEENTRY *pPalette,
LPDIRECT3DTEXTURE8 *ppTexture);

The D3DXCreateTextureFromFileEx function exposes the parameters from CreateTexture along with some new ones. When you set the width and height, a value of D3DX_DEFAULT tells D3DX to use the size of the source image. The filter parameters describe how the image is to be filtered when it is being resized to fit the texture or to build mip maps. If a color key is specified, that color is transparent in the loaded texture. You can use the D3DXIMAGE_INFO structure to retrieve information about the source image. Finally, you can use the palette structure to a set a palette. Because you are using 32-bit textures, this parameter should be set to NULL.

The D3DX texture creation functions are capable of reading several different file formats, but remember that the amount of texture memory used by the texture depends on the pixel format of the texture, not the size of the file. For instance, if you load a JPEG file as a texture, chances are that the texture will take up much more memory than the size of the JPEG file.

The D3DX functions create the new texture in managed memory. They also try to create a valid texture size for the image. For instance, if the image is 640×480, it might try to create a 1,024×512 texture to satisfy the powers-of-two requirement, or it might try to create a 256×256 texture to satisfy a size limitation of the hardware. In either case, the image is stretched to fill the created texture. This can be advantageous because you are almost guaranteed that you can load images of nearly any size, but stretching can produce artifacts or other undesirable side effects. The best way to prevent this is to size textures appropriately when you are creating the files. That way, you can get the best quality textures and use space as efficiently as possible.

### Textures and Vertices

How to create the texture was discussed above, but the texture isn't really worth much if you can't use it with your vertices. So far, the rendering you have done has used simple colored triangles. This is because your vertex format has included only color information. To use textures, you need to augment the vertex format with information about how the texture will be mapped onto the geometry. You do this with texture coordinates.

Texture coordinates map a given vertex to a given location in the texture. Regardless of width and height, locations in the texture range from 0.0 to 1.0 and are typically denoted with u and v. Therefore, if you want to draw a simple rectangle displaying the entire texture, you can set the vertices with texture coordinates (0.0, 0.0), (1.0, 0.0), (0.0, 1.0) (1.0, 1.0), where the first set of coordinates is the upper-left corner of the texture and the last set is the lower-right corner. In this case, the shape of the texture on the screen depends on the vertices, not the texture dimensions. For instance, if you have a 128×128 texture, but the vertices are set up to cover an entire 1,024×768 screen, the texture is stretched to cover the entire rectangle. In the general case, textures are stretched and interpolated between the texture coordinates on the three vertices of a triangle.

Texture coordinates are not limited to the values of 0.0 or 1.0. Values less than 1 index to the corresponding location in the texture. In a diagram you can map a texture using different values. In these examples, every piece of data is the same except for the texture coordinates.

Textures coordinates are not limited to the range of 0.0 to 1.0 either. In the default case, values greater than 1 result in the texture being repeated between the vertices. In the next chapter, you'll look at some ways that you can change the repeating behavior, but repeating the texture is the most common behavior. A diagram can show how you can use this to greatly reduce the size of your texture if the texture is a repeating pattern. Imagine a checkerboard fills the screen for a simple game of checkers. You can create a large texture that corresponds to the screen size, but it is better to have a small texture and let the device stretch it for you. Better yet, because of the nature of a checkerboard, you can have a very small texture that is a small portion of the board and then repeat it. By doing this, the texture is 1/16 the size of the full checkerboard pattern and a lot smaller than the image that appears on the screen. This reduces the amount of data that needs to move through the pipeline.

These are just some simple examples of how texture coordinates work, but the concepts hold true in less straightforward cases. If you create a triangle shaped like a tiny sliver and you map the texture onto that, the texture is stretched and pulled to cover the triangle. The next chapter talks a little more about how the device processes the texture when it is being stretched.

Now that you have looked at how texture coordinates work, let's look at how to add them to your vertex format. A device can use up to eight different textures (although this might be limited by the specific hardware you're using). The following FVF definition defines your vertex as having one set of texture coordinates. D3DFVF_TEX1 is used for one texture, D3DFVF_TEX2 is used for two, and so on:

#define D3DFVF_TEXTUREDVERTEX (D3DFVF_XYZ |

D3DFVF_DIFFUSE | D3DFVF_TEX1)

struct TEXTUREDVERTEX
{

FLOAT x, y, z;
DWORD d;
FLOAT u, v;

};

So far, the discussion has been limited to 2D textures because those are the most widely used, but it is possible to have a 1D texture, which is just like any other texture, but with a height of 1. 1D textures can be useful with vertex or pixel shaders. The format for a vertex with a 1D texture coordinate follows. In this case, the D3DFVF_TEXCOORDSIZEx flag tells the device there is only one texture coordinate:
#define D3DFVF_TEXTUREDVERTEX (D3DFVF_XYZ|D3DFVF_DIFFUSE|D3DFVF_TEX1|3D3FVF_TEXCOORDSIZE1(0))

Although the present invention has been described in relation to particular embodiments thereof, many other variations and modifications and other uses will become apparent to those skilled in the art. For example, such variation might include but not limited to using the presently disclosed method to produce test target and scan images of inspection signals generated by all types of NDT/NDI instruments. It is preferred, therefore, that the present invention not be limited by the specific disclosure herein, but only by the appended claims.

What is claimed is:

1. A computer image processing method suitable for a non-destructive inspection device used by an operator to produce a representation of inspection signals obtained from a scanned area of a test object and a representation of a view of the test object, wherein the scanned area includes possible defects, the method comprising the steps of:
a1) creating a first surface representing the view of the test object according to a predetermined geometric definition of the test object;
a2) dividing the first surface into a plurality of a first set of primitives;
a3) applying texture onto the first surface according to an operator's designation of any combination of color, opacity and/or fill-patterns;
b1) creating a second surface to match the scanned area;
b2) meshing the second surface into a plurality of a second set of primitives;
b3) converting the inspection signals to a set of corresponding texture data; and creating inspection signal texture for the second surface by mapping the inspection signal texture data onto the corresponding second primitives, the inspection signal texture including any combination of color, opacity and/or fill-in patterns;
c1) providing the first and the second surface, the first set of and the second set primitives and the corresponding textures as input to a computer graphics accelerator program; and
c2) executing the graphics accelerator program to produce the representation of the inspection signals reflecting geometry characteristics of the possible defects and the scan area and to produce the representation of the view of the test object accordingly on an electronic display.

2. The method of claim 1, wherein the geometric definition of the first surface is defined and retrieved from a computer aided design tool.

3. The method of claim 1, wherein the view of the test object includes any cross-section or any view of the entire test object.

4. The method of claim 1, wherein the view of the test object includes any cross-section and any view of any selected portion of the test object, selected according to analyzing tools including markers, inspection gates and/or grids.

5. The method of claim 1, wherein the representation of the scan area includes representation of the possible flaw and the representation of the geometric characteristic of the scanned area.

6. The method of claim 1, wherein producing the representations of inspection signals and the test object are carried out in real time as inspection signals are obtained by the inspection device.

7. The method of claim 1, wherein the step of dividing the first surface into a plurality of primitives further comprises the steps of,
creating vertexes over the first surface;
creating the primitives based on the vertexes.

8. The method of claim 1, wherein the step of meshing the second surface into a plurality of primitives further comprises the steps of,
creating vertexes over the surface; and
creating vertex coordinates for the vertexes; and
creating the primitives based on the vertexes.

9. The method of claim 1, wherein the first set and the second set of primitives have established coordinate values within a first and second coordinate systems, respectively, and further including translating the coordinate values to the other coordinate system.

10. The method of claim 1, wherein the inspection signals are ultrasonic signals which are provided in a format of an S-scan by the inspection device.

11. The method of claim 1, wherein the inspection signals are ultrasonic signals which are provided in a format of a C-scan by the inspection device.

12. The method of claim 1, wherein the inspection device is an ultrasonic inspection device.

13. The method of claim 1, wherein the inspection device is an eddy current inspection device.

14. A computer image processing system used in conjunction with non-destructive inspection device, suitable for producing representation of non-destructive inspection signals obtained from a scanned area of a test object and the representation of a view of the test object, wherein the scanned area includes possible defects, the system comprising:
a test object geometry treatment module which further includes,
a test object geometry data loader for retrieving the geometry definition of the view of the test object,
a test object surface generator for dividing the view of the test object into a first set of primitives and to generate the test object surface; and
a test object texture assigner for assigning texture onto the test object surface;
a scan area surface treatment module which further includes,
a scan area surface generator configured to create a scan area surface by matching the scanned area and meshing the surface into a plurality of scan area primitives having predetermined geometric shapes;
a scan area texture generator configured to convert the inspection signals to a set of corresponding texturized signal data and to create a texture for the scan area by mapping the texturized signal data onto the corresponding scan area primitives;
an image rendering module using the information on the test object primitives and the scan area primitives, the corresponding test object textures and scan area textures as input to a computer graphics accelerator, wherein the graphics accelerator is configured to produce the representation of the inspection signals reflecting geometry characteristics of the possible defects and the scan area and to produce the representation of the view of the test object on an electronic display.

15. The system of claim 14, wherein the texture includes any level of any combination of color, opacity and/or fill-patterns.

16. The system of claim 14, wherein the geometric definition of the test object is created by a computer aided design tool.

17. The system of claim 14, wherein producing the representation of the inspection signals reflecting geometry characteristics of the possible defects and the scan area and the representation of the view of the test object on an electronic display is carried out in real time as inspection signals are obtained by the inspection device.

18. The system of claim 14, wherein the view of the test object includes any cross-section and any view of any selected portion of the test object, selected according to analyses tools including markers, inspection gates and/or grids.

19. The system of claim 14, wherein the inspection device is an ultrasonic inspection device.

20. The method of claim 14, wherein the inspection device is an eddy current inspection device.
